(19) United States
(12) Patent Application Publication
(10) Pub. No.: US 2026/0228705 A1
(43) Pub. Date: Aug. 6, 2026

(54) ARRANGEMENT AND REINFORCEMENT OF DEBRIS PILES

(71) Applicant: International Business Machines Corporation, Armonk, NY (US)

(72) Inventors: Martin G. KEEN, Cary, NC (US); Carolina GARCIA DELGADO, Zapopan (MX); Sarbajit Kumar RAKSHIT, Kolkata (IN); Jennifer M. HATFIELD, Portland, OR (US)

(21) Appl. No.: 19/045,883

(22) Filed: Feb. 5, 2025

(51) Int. Cl. G06Q 10/30; G01D 5/54

(52) U.S. Cl. CPC G06Q 10/30; G01D 5/54

(57) ABSTRACT

Method and apparatus for herein relate to an improvement in generating stable debris piles at dump sites, or the like. Pieces of debris from construction sites can be scanned by a 3-D scanner to identify properties of the debris. For example, the debris' material, estimated weight, shape, etc. can be predicted once it is scanned. Using the information collected from the 3-D scan, the stability of the debris can be predicted. Once the stability is predicted, the debris is instructed to be placed at a certain pile at the dump site that is likely to maintain a level stability with the addition of the scanned debris. Once the debris is placed on the pile, the actual stability of the pile is measured against the predicted stability of the pile.

### BACKGROUND

The present invention relates to debris collection, and more specifically, to organizing debris piles. Debris piles can form at construction sites or demolition sites where materials such as concrete, wood, metal, etc. are removed during building renovation or teardown projects, or the like. These piles are created as a way to temporarily store discarded materials before they are sorted or removed. Debris can be transported from these sites to landfills, recycling facilities, dumping grounds, etc. After being transported, the piles where the debris is placed may be unstable or inefficiently constructed.

### SUMMARY

According to an embodiment, a method includes: identifying a shape of debris for disposal; determining, from the shape and using a convolutional neural network (CNN), a material type and estimated weight of the debris; performing, using one or more computer processors, a finite element method (FEM) analysis on the debris using the shape, material type, and estimated weight of the debris to predict a stable location of the debris in the dump site to place the debris; and unloading the debris from a transportation vehicle onto a pile at the predicted stable location.

According to another embodiment, a computer system for identifying privileged access to a database, the computer system including: one or more computer processors; one or more computer readable storage media; and program instructions stored on the computer readable storage media for execution by at least one of the one or more processors, the program instructions including: identifying a shape of debris for disposal; determining, from the shape and using a convolutional neural network (CNN), a material type and estimated weight of the debris; performing, using one or more computer processors, a finite element method (FEM) analysis on the debris using the shape, material type, and estimated weight of the debris to predict a stable location of the debris in the dump site to place the debris; and unloading the debris from a transportation vehicle onto a pile at the predicted stable location.

According to another embodiment, a computer program product for debris particle arrangement, the computer program product including: a computer-readable storage medium having computer-readable program code embodied therewith, the computer-readable program code executable by one or more computer processors configured to perform operations including: identifying a shape of debris for disposal; determining, from the shape and using a convolutional neural network (CNN), a material type and estimated weight of the debris; performing, using one or more computer processors, a finite element method (FEM) analysis on the debris using the shape, material type, and estimated weight of the debris to predict a stable location of the debris in the dump site to place the debris; and unloading the debris from a transportation vehicle onto a pile at the predicted stable location.

### BRIEF DESCRIPTION OF THE DRAWINGS

FIG. 1 illustrates a functional block diagram illustrating a networked environment, in accordance with an example embodiment of the present invention.

FIG. 2 illustrates a computing system for analyzing scanned debris, according to some embodiments.

FIG. 3 illustrates a flow diagram showing where the debris should be placed, according to some embodiments.

FIG. 4 illustrates a finite element method (FEM) analysis system, according to some embodiments.

FIG. 5 illustrates transporting a debris particle, according to some embodiments.

FIG. 6 illustrates a flow diagram of updating parameters of the computing system, according to some embodiments.

### DETAILED DESCRIPTION

Embodiments herein relate to generating stable debris piles at dump sites, or the like. In one embodiment, pieces of debris from construction sites are scanned by a 3-D scanner to identify properties of the debris. For example, the debris' material, estimated weight, shape, etc. can be predicted once it is scanned. The predicted stable arrangement is validated against a previously validated data set of a plurality of similar debris particles. Using the information collected from the 3-D scan, the stability of the debris can be predicted. Once the stability is predicted, the system instructs the debris to be placed at a certain pile at the dump site that is likely to remain stable with the addition of the scanned debris.

In one embodiment, once the debris is placed on the pile, the actual stability of the pile is measured against the predicted stability of the pile. If the stability level of the pile falls below a predetermined threshold, the parameters used in finite element method (FEM) analysis can be adjusted so that it can more accurately predict stability in the future.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the FEM analyzer 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

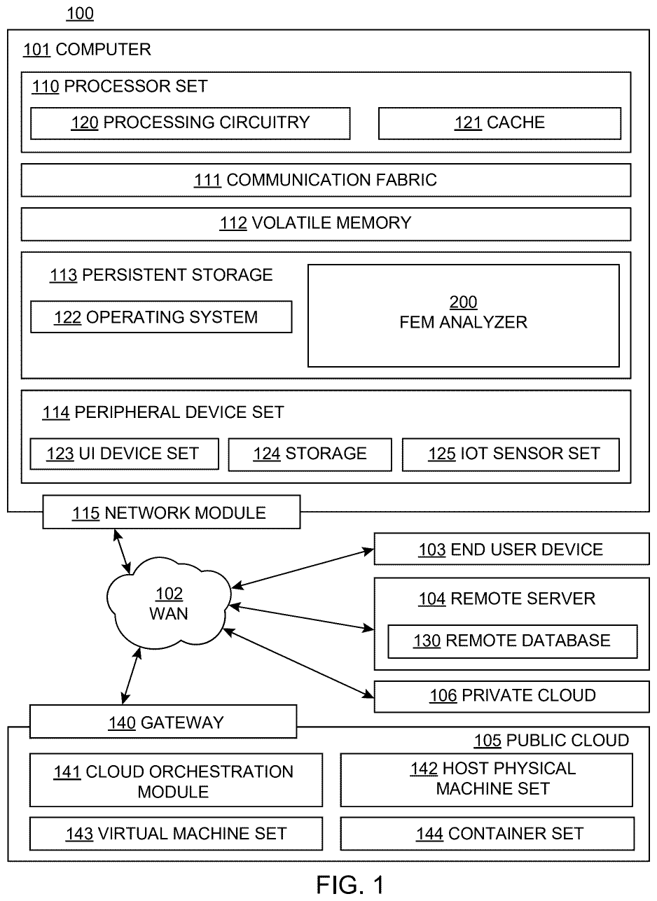

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

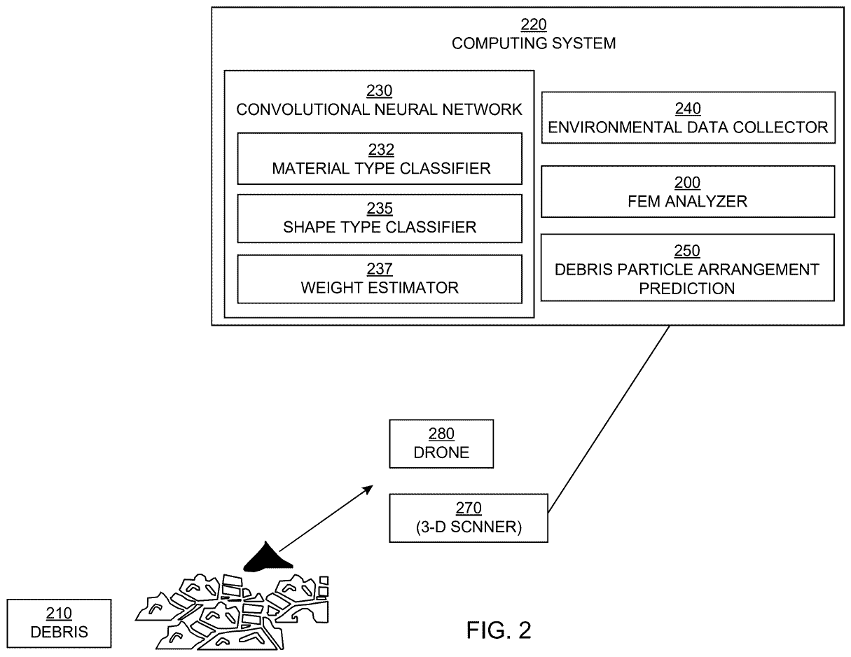

FIG. 2 illustrates a 3-D scan of a debris, and the computing system 220 that predicts a stable pile, or arrangement where the debris can be placed.

The debris 210 can be scattered fragments or waste material resulting from construction, demolition, natural disasters, or other activities. It can include a variety of materials, such as wood, concrete, metal bricks, etc. A 3-D scanner 270 can be attached to a lamp post, a drone hovering over the site of the debris 210, mounted to a vehicle, etc. to scan the debris 210. The 3-D scanner 270 can capture the geometry of the debris 210 by emitting laser beams, structured light, capturing images from multiple angles, etc.

Once the 3-D scan of the debris 210 is captured, the computing system 220 uses various components to analyze the scan the debris 210. This scan and analysis helps the computing system predict a stable pile at a dump site where the debris will be transfer, for the debris 210 to be placed. In some embodiments, the debris 210 can be scanned as it enters a dump site as the debris 210 is mounted to a truck or other container. The computing system 220 includes a convolutional neural network (CNN) 230 component, an environmental data collector 240, a FEM analyzer 200 and a debris particle arrangement predictor 250.

The CNN 230 contains a material type classifier 232, a shape type classifier 235, and a weight estimator 237. The CNN 230 can predict the material type, shape and weight of the scanned debris 210 by analyzing the received visual or sensor data, and learning features associated with the scanned properties. The CNN 230 can process data though multiple layers, extracting increasingly abstract representations of the data used to make predictions.

The material type classifier 232 of the CNN 230 can identify certain visual characteristics, such as textures, colors, or patterns present on the object's surface. For example, metal can exhibit a shiny, reflective texture whereas wood can show a grainy pattern. By training on labeled images of various materials, the CNN 230 can learn to distinguish features, such as the features of the discussed example, more accurately. Additionally, hyperspectral or multispectral data can enhance predictions by capturing subtle spectral signatures distinctive of certain materials.

The shape type classifier 235 of the CNN 230 can predict the shape of the debris' 210 non visible sections by analyzing the visible geometry, contours, and spatial relationships of the debris' 210 3-D scan. The shape type classifier 235 can process depth maps, point clouds, or voxel representations to understand the debris' 210 spatial form. By training the CNN 230 with a dataset of diverse shapes, the CNN 230 can learn to identify geometric properties and classify or reconstruct debris of varying complexity.

The weight estimator 237 uses the information from the material classifier 232 and the shape type classifier 235 to infer the debris' 210 potential weight. The weight estimator 237 can correlate the debris' 210 material type with its shape to find the potential weight of the debris 210. For example, a metallic cube may be heavier than a wooden cube of the same dimensions due to the density of the metal. During training, the weight estimator 237 can use labeled data where the metal's weight per unit of measure is provided, allowing the weight estimator 237 to learn to associate certain material and volume features with weight. Combining visual data with other inputs, such as 3-D volume or sensor derived dimensions, can improve the accuracy of weight predictions.

The environmental data collector 240 determines whether environmental conditions at the site of the dump for the debris disposal will affect the stability of of a potential pile. Environmental data can be collected at a drone at the dump site, which can be equipped with a combination of sensors, sampling techniques or monitoring systems. Environmental factors collected and evaluated at the environmental data collector 240 can include air quality, which can be assessed with sensors that measure pollutants such as methane, carbon dioxide, and particulate matter. Soil samples can also be collected to test for contamination by heavy metals, chemicals, or toxins from waste. Soil sample data can be reported to the environmental data collector 240. Groundwater and surface water can also be monitored through boreholes and nearby water bodies to detect pollutants such as nitrates or organic compounds, and this collected data can also be reported to the environmental data collector 240. Additionally, noise levels, temperature and weather conditions can be recorded via environmental monitoring stations, with data reported to the environmental data collector 240. These are non-limiting examples of environmental factors and ways they can be recorded and presented to the environmental data collector 240.

The FEM analyzer 200 is a simulation that takes into account the information from the environmental data collector 240 and the CNN 230 to predict the ways different arrangements of the debris 210 will bear loads and respond to environmental stressors. The FEM analyzer 200 then outputs a debris particle arrangement prediction 250, indicating a stable pile and arrangement at a monitored dump site that the debris 210 should be placed.

The FEM analyzer 200 simulates applying a force to the debris 210 itself, and simulates the force that will be applied by the debris 210 to an existing pile of debris, arranged in a first position a second position, and so on. Behavior can include the debris 210 or the pile the debris would be placed in, moving, caving in, remaining stable, etc. Using this information, the FEM analyzer 200 can predict a stable arrangement based on the simulation of the debris particle arranged in the first position, the simulation of the debris particle is arranged in the second position, and a predicted position of failure.

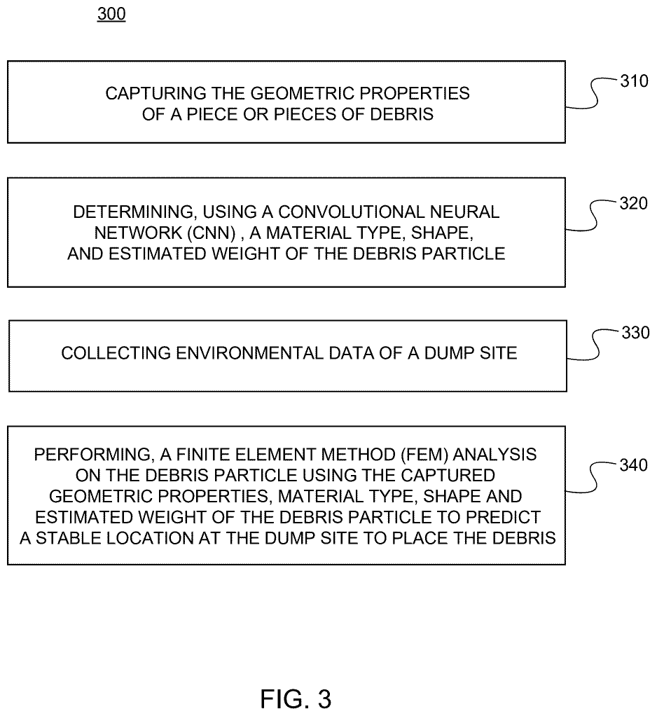

FIG. 3 illustrates a flow diagram 300 of the process leading to the debris particle arrangement prediction 250.

At block 310 the geometric properties of the piece or pieces of debris is captured. As described in FIG. 2, at a construction site, or site where debris is being generated, lampposts, independently arranged posts, drones, entrances, etc. can be equipped with 3-D sensors. The 3-D sensors can scan debris as it enters the site, or as it being collected and loaded onto vehicles at the site.

The 3-D sensors can use a variety of technologies to capture the geometric properties of debris. In some embodiments, the 3-D sensor is equipped with a computing system embedded in the sensor, whereas in other embodiments, the 3-D sensor sends the data it captures to an off-site computing system 220.

At block 320 the computing system 220 uses a CNN 230 to predict the material type, shape, and estimated weight of the debris particle. As described in FIG. 2, the CNN 230 uses a material type classifier 232 and a shape type classifier 235 to feed a weight estimator 237 with information that ultimately helps the CNN predict the weight of the scanned debris 210.

At block 330, a plurality of sensors, which can also be deployed on lampposts, found on drones, etc. at the dump site, report environmental data to the environmental data collector 240. As discussed in FIG. 2, the environmental data collector 240 is a database storing information regarding the environment of the dump site to help determine if there would be environmental factors that can influence the stability prediction of the debris 210.

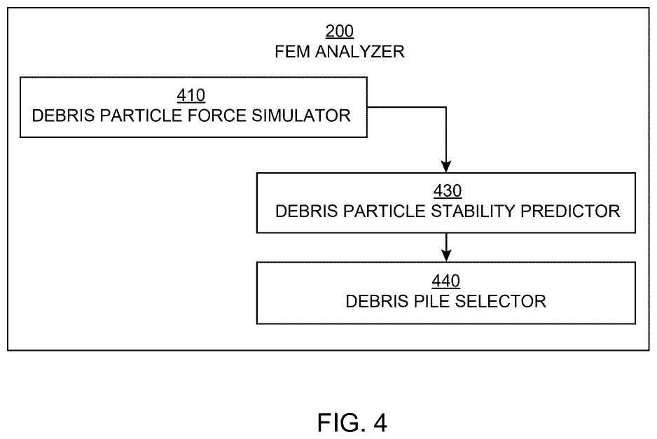

At block 340 a FEM analyzer 200 performs a FEM analysis on the debris particle using the captured geometric properties, material type, shape, environmental factors, and estimated weight of the debris particle to predict a stable location at the dump site to place the debris. As discussed in FIG. 2, in one embodiment the FEM analyzer 200 simulates different positions the debris 210 can be placed in, and simulates forces being applied to the debris 210 as it sits in those positions. Using these simulations, the FEM analyzer 200 determines a stable position of the debris 210, and a pile that it can be placed in at the dump site so that its stability is maintained. The FEM analyzer 200 is described in more detail in FIG. 4.

FIG. 4 illustrates more details of the FEM analyzer 200. The components of the FEM analyzer 200 can include a debris particle simulator 420, a debris particle stability predictor 430, and a debris pile selector 440.

The debris particle force simulator 410 is simulates placing the debris 210 in different positions, and simulates the force the debris 210 would apply to the existing pile as in different placement positions. Simulating the position of an object can involve modeling its motion and interaction with its environment using principals of physics and computational techniques. Numerical simulation framework in the debris particle force simulator 410 can simulate a position of the debris 210. This force simulation can include modifying an applied acceleration based on a force and mass. The direction and magnitude of the force can be incorporated in the simulation. Simulations in the debris particle force simulator 410 can involve constraints and collision handling to ensure realistic behavior of the debris 210 under the simulated conditions. The debris particle force simulator 410 uses data available from the environmental data collector 240 and the CNN 230 to predict the behavior of the debris 210 under the simulated conditions.

After data from the debris particle force simulator 410 is collected, the debris stability predictor 430 analyzes the current (or actual) stability of the current piles of debris at a dumping site for the debris 210, to determine if debris can serve as a structural support for more debris in the future. The stability of the debris piles at the dumping site and the structural support potential of the debris 210 can be evaluated using a network of sensors that monitors a tilt level, vibration level, and pressure level of the pile. The debris particle stability predictor 430 assesses the stable position predicted by the debris particle for simulator 410 for the debris particle 210 in relation to different piles at the dumping site. The debris particle stability predictor 430 predicts a stability level of the debris piles at the dumping site assuming the debris particle 210 is placed in the pile. Using this information, the debris pile selector 440 selects a debris pile and position of the debris 210 that would produce a debris pile with a predicted stability level that falls above a predetermined threshold indicating an appropriate level of stability of the pile.

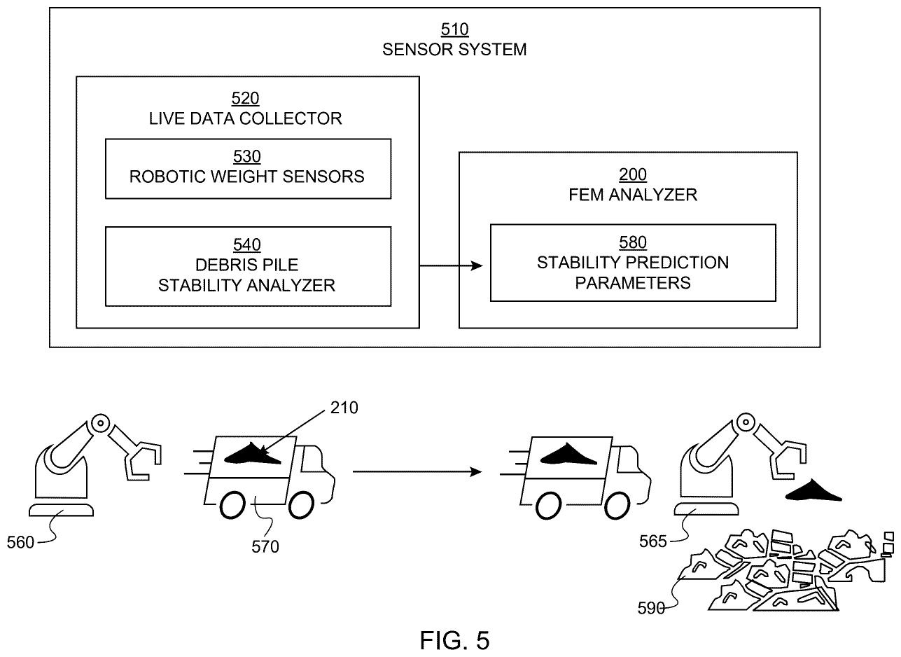

FIG. 5 illustrates a sensor system 510 that provides data to the FEM analyzer 200 during the live process of moving the debris 210 to its selected pile. Depending on the results determined by the sensor system 510, the stability prediction parameters 580 of the FEM analyzer 200 can be updated accordingly.

The sensor system 510 includes a live data collector 520. The live data collector 520 collects information from robotic weight sensors 530 and a network of sensors that provides information to a debris pile stability analyzer 540. The robotic weight sensors 530 can be found on robotic arms 560 and 565 that place the debris 210 onto a truck 570, or from the truck 570 onto a debris pile 590. The truck 570 moves the debris from its initial location to the dumping site where a destination debris pile. Also included in the live data collector 520 is a debris pile stability analyzer 540. Similar to the debris particle stability predictor, the debris particle stability analyzer collects data from the debris pile 590 before and after the debris 210 is dropped off there. The debris pile stability analyzer 540 compares the actual stability level of the pile 590 after the debris 210 has been dropped off to what the stability level of the debris pile 590 is predicted to be after the debris 210 is dropped off by the debris particle stability predictor 430. If the stability level after the debris 210 has been dropped in the pile 590 differs from what was predicted, or if the stability level of the pile falls below a predetermined threshold, the stability prediction parameters 580 of the FEM analyzer 200 are updated to reflect this change, enabling more accurate predictions in the future.

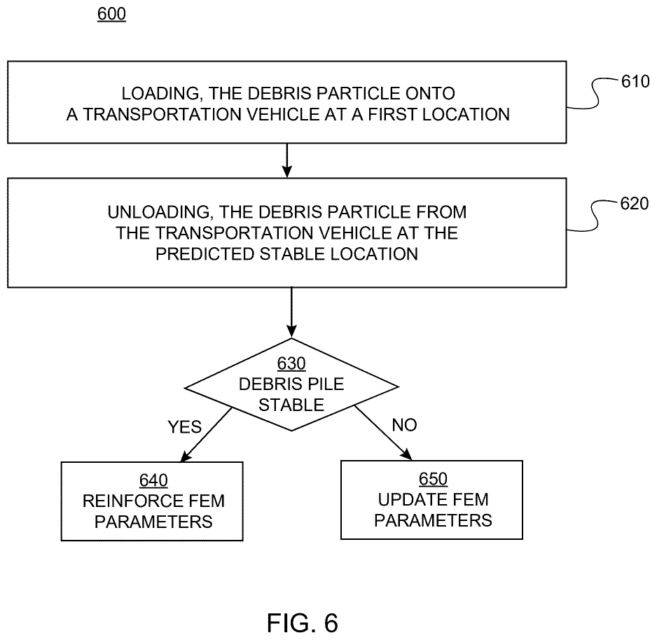

FIG. 6 illustrates a flow diagram 600 for updating the prediction parameters 580 of the FEM analyzer 200.

At block 610 the debris 210 is loaded into a transportation vehicle at the location where the debris was created. At this stage, it is assumed the destination pile for the debris has already been determined, as described in FIG. 3. As mentioned in FIG. 5, the debris 210 can be loaded manually, or with robotic arms that collect live data of the weight of the debris. The live data of the weight can be compared to the predicted weight, and used to update the parameters of the CNN 230.

At block 620 the debris 210 is unloaded from the transportation vehicle 570 at the predicted stable location. As discussed in FIG. 2, the predicted stable location is predicted based on monitoring the different piles' stability, and using the FEM analyzer 200 to predict a stable pile and positioning for the scanned debris particle 210.

At block 630 the debris pile stability analyzer 540 determines a stability level of the debris pile 590, before and after the debris 210 is placed on the pile. As discussed in FIG. 5, the stability level after the debris 210 is placed in the pile 590 is compared to the predicted stability of the pile, as predicted by the FEM analyzer 200.

At block 650, if the debris pile is not as stable as predicted by the FEM analyzer 200, the parameters if the FEM analyzer's 200 debris particle stability predictor 430 are updated, as described in FIG. 5.

At block 640 if the debris pile is as stable as predicted by the FEM analyzer 200, the parameters if the FEM analyzer's 200 debris particle stability predictor 430 are reinforced, as described in FIG. 5.

While the foregoing is directed to embodiments of the present invention, other and further embodiments of the invention may be devised without departing from the basic scope thereof, and the scope thereof is determined by the claims that follow.

1. A method comprising:
identifying a shape of debris for disposal;
determining, from the shape and using a convolutional neural network (CNN), a material type and estimated weight of the debris;
performing, using one or more computer processors, a finite element method (FEM) analysis on the debris using the shape, material type, and estimated weight of the debris to predict a stable location of the debris in a dump site to place the debris; and
unloading the debris from a transportation vehicle onto a pile at the predicted stable location.

2. The method of claim 1 further comprising:
monitoring, using a network of sensors, a stability level of the pile the debris is placed on; and
upon determining the stability level of the pile falls below a predetermined threshold, adjusting parameters used in the FEM analysis of the debris to reflect the stability level of the of the pile the debris is placed on.

3. The method of claim 2, wherein the network of sensors, monitors a tilt level, vibration level and pressure level of the pile.

4. The method of claim 1, wherein a predicted stable arrangement is validated against a previously validated data set of a plurality of similar debris particles.

5. The method of claim 1, wherein the FEM analysis comprises:
simulating applying a force to the debris arranged in a first position; and
simulating applying the force to the debris arranged in a second position;
predicting a position of failure for the debris based on the simulation of the debris arranged in the first position and the simulation of the debris arranged in the second position; and
predicting a stable arrangement based on the simulation of the debris arranged in the first position, the simulation of the debris is arranged in the second position, and the predicted position of failure.

6. The method of claim 1 wherein the debris is loaded onto a transportation vehicle using a robotic component equipped with weight sensors.

7. The method of claim 1, wherein determining whether the debris can serve as a structural support comprises a reinforcement learning system that compares the debris to a plurality of previously determined structurally supportive debris.

8. A computer system for debris particle arrangement, the computer system comprising:
one or more computer processors;
one or more computer readable storage media; and
program instructions stored on the computer readable storage media for execution by at least one of the one or more processors, the program instructions comprising:
identifying, using a 3D scan, a shape of debris for disposal;
determining, from the shape and using a convolutional neural network (CNN), a material type and estimated weight of the debris;
performing, using one or more computer processors, a finite element method (FEM) analysis on the debris using the shape, material type, and estimated weight of the debris and environmental data of the dump site to predict a stable location of the debris in a dump site to place the debris; and
unloading the debris from a transportation vehicle onto a pile at the predicted stable location, wherein the debris is loaded onto the transportation vehicle using a robotic component equipped with weight sensors.

9. The system of claim 8, further comprising:
monitoring, using a network of sensors at the dump site, a stability level of the pile the debris is placed on; and
upon determining the stability level of the pile falls below a predetermined threshold, adjusting parameters used in the FEM analysis of the debris to reflect the stability level of the of the pile the debris is placed on for more accurate future stability prediction.

10. The system of claim 9, wherein the network of sensors, monitors a tilt level, vibration level and pressure level of the pile, before and after the debris is placed on the pile.

11. The system of claim 8, wherein a predicted stable arrangement is validated against a previously validated data set of a plurality of similar debris particles, the plurality of similar debris particles having geometric properties, material types, or estimated weights corresponding to the debris.

12. The system of claim 8, wherein the FEM analysis comprises:
simulating applying a force to the debris arranged in a first position; and
simulating applying the force to the debris arranged in a second position;
predicting a position of failure for the debris based on the simulation of the debris arranged in the first position and the simulation of the debris arranged in the second position; and
predicting a stable arrangement based on the simulation of the debris arranged in the first position, the simulation of the debris is arranged in the second position, and the predicted position of failure, wherein the stable arrangement is selected to produce a predicted stability level above a predetermined threshold.

13. The system of claim 8 wherein the debris is loaded onto a transportation vehicle using a robotic component equipped with weight sensors, and weight data from the weight sensors is compared with the estimated weight of the debris.

14. The system of claim 8, wherein determining whether the debris can serve as a structural support comprises a reinforcement learning system that compares the debris to a plurality of previously determined structurally supportive debris, and predicts whether the debris can serve as structural support for more debris in the pile.

15. A computer program product for debris particle arrangement, the computer program product comprising:
a computer-readable storage medium having computer-readable program code embodied therewith, the computer-readable program code executable by one or more computer processors configured to perform operations comprising:
identifying a shape of debris for disposal;
determining, from the shape and using a convolutional neural network (CNN), a material type and estimated weight of the debris;
performing, using one or more computer processors, a finite element method (FEM) analysis on the debris using the shape, material type, and estimated weight of the debris to predict a stable location of the debris in a dump site to place the debris, wherein a predicted stable arrangement is validated against a previously validated data set of a plurality of similar debris particles;
unloading the debris from a transportation vehicle onto a pile at the predicted stable location; and
monitoring, using a network of sensors, a stability level of the pile before and after the debris is placed on the pile, and upon determining that the stability level of the pile falls below a predetermined threshold or differs from a predicted stability level, adjusting parameters used in the FEM analysis of the debris to reflect the stability level of the pile.

16.(canceled)

17. (canceled)

18. (canceled)

19. The computer program product of claim 15, wherein the FEM analysis comprises:
simulating applying a force to the debris arranged in a first position; and
simulating applying the force to the debris arranged in a second position;
predicting a position of failure for the debris based on the simulation of the debris arranged in the first position and the simulation of the debris arranged in the second position; and
predicting a stable arrangement based on the simulation of the debris arranged in the first position, the simulation of the debris is arranged in the second position, and the predicted position of failure.

20. The computer program product of claim 15, wherein the debris is loaded onto a transportation vehicle using a robotic component equipped with weight sensors.

21. The method of claim 1, wherein the FEM analysis comprises simulating behavior of the debris in a plurality of different positions relative to a pile and predicting a stable arrangement for the debris based on the simulated behavior.

22. The method of claim 1, wherein the FEM analysis comprises simulating behavior of the debris in a plurality of different positions relative to a pile and predicting a stable arrangement for the debris based on the simulated behavior, wherein the simulated behavior comprises simulating force applied to the debris in different positions relative to the pile and predicting a failure condition for at least one of the different positions.

23. The method of claim 1, wherein the FEM analysis comprises simulating behavior of the debris in a plurality of different positions relative to a pile and predicting a stable arrangement for the debris based on the simulated behavior, wherein the simulated behavior comprises simulating force applied to the debris in different positions relative to the pile and predicting a failure condition for at least one of the different positions, wherein predicting the stable arrangement comprises selecting a position for the debris based on the simulated behavior and the predicted failure condition.
